(19) United States
(12) Patent Application Publication
(10) Pub. No.: US 2010/0072134 A1
(43) Pub. Date: Mar. 25, 2010

(54) ULTRASONICALLY INDUCED CAVITATION OF FLUOROCHEMICALS

(76) Inventor: Brian T. Mader, Marine on the St. Croix, MN (US)

Correspondence Address: 3M INNOVATIVE PROPERTIES COMPANY, PO BOX 33427, ST. PAUL, MN, 55133-3427, US

(21) Appl. No.: 12/519,457

(22) PCT Filed: Feb. 6, 2008
(86) PCT No.: PCT/US08/53130

§ 371 Date: Jun. 16, 2009

Related U.S. Application Data
(60) Provisional application No. 60/893,260, filed on Mar. 6, 2007.

(51) Int. Cl. C02F 1/36; C02F 1/44; C02F 101/14

(52) U.S. Cl. 210/638; 210/205; 210/202; 210/748.04

(57) ABSTRACT

A system is described for the treatment of fluorochemicals in an aqueous environment, the system includes: a first treatment station configured to receive a first stream or volume of water comprising fluorochemicals, the first treatment station configured to provide a first treatment to the first stream or volume of water to thereby provide a second stream or volume of water comprising fluorochemicals; and a second treatment station configured, to treat the second stream or volume of water by ultrasonically induced cavitation at a frequency within the range from about 15 kHz to about 1100 kHz. A process for the treatment of fluorochemicals in water is also described, the process comprising: applying a first treatment to a first stream or volume of water comprising fluorochemicals, the first treatment producing a second stream or volume of water comprising fluorochemicals; and applying a second treatment to the second stream or volume of water, the second treatment comprising ultrasonically induced cavitation at a frequency within the range from about 15 kHz to about 1100 kHz to thereby breaking down the fluorochemicals into constituent components. The first treatment station is a filtration station, a reverse osmosis station, an ultrafiltration station or nanofiltration station.

The present invention relates to a system and process for the treatment of fluorochemicals in an aqueous environment.

### BACKGROUND

Fluorochemicals have been used in a variety of applications including the water-proofing of materials, as protective coatings for metals, as fire-fighting foams for electrical and grease fires, for semi-conductor etching, and as lubricants. The main reasons for such widespread use of fluorochemicals is their favorable physical properties which include chemical inertness, low coefficients of friction, and low polarizabilities (i.e., fluorophilicity). Specific types of fluorochemicals include perfluorinated surfactants, perfluorooctane sulfonate (PFOS) and perfluorooctanoic acid (PFOA).

Although fluorochemicals are valuable as commercial products, they can be difficult to treat using conventional environmental remediation strategies or waste treatment technologies. Moreover, certain conventional treatment technologies may be ineffective for the treatment of fluorochemicals such as PFOS and PFOA when these compounds are present in the aqueous phase. Advanced oxidation processes that employ hydroxyl radicals derived from ozone, peroxone, or Fenton's reagent have been shown to react with PFOA, but these reactions tend to progress very slowly. PFOS and PFOA can be reduced by reaction with elemental iron under near super-critical conditions, but problems have been noted in the scale-up of a high-pressure, high temperature treatment system for implementing this reduction chemistry.

Improvements in the treatment of fluorochemicals are desired.

### SUMMARY

In one aspect, the present invention provides a system for the treatment of fluorochemicals in an aqueous environment, comprising:
A first treatment station configured to receive a first stream or volume of water comprising fluorochemicals, the first treatment station configured to provide a first treatment to the first stream or volume of water to thereby provide a second stream or volume of water comprising fluorochemicals;
A second treatment station configured to receive the second stream or volume of water from the first treatment station, the second treatment station configured to treat the second stream or volume of water by ultrasonically induced cavitation at a frequency within the range from about 15 kHz to about 1100 kHz.

In another aspect, the invention provides a process for the treatment of fluorochemicals in water, comprising:
Applying a first treatment to a first stream or volume of water comprising fluorochemicals, the first treatment producing a second stream or volume of water comprising fluorochemicals; and
Applying a second treatment to the second stream or volume of water, the second treatment comprising ultrasonically induced cavitation at a frequency within the range from about 15 kHz to about 1100 kHz to thereby breaking down the fluorochemicals into constituent components.

Terms used herein will be understood to have the same meaning as that understood by those skilled in the art. For clarity, certain terms are defined herein.

“Cavitation” refers to the formation, growth, and implosive collapse of bubbles in a liquid.

“Fluorochemical” means a halocarbon compound in which fluorine replaces some or all hydrogen molecules.

“Microfiltration” means a filtration media having a pore sizes from about 0.1 micron to about 3 micron.

“Nanofiltration” means a filtration media having a pore sizes between about 0.0005 micron (5 Angstroms) and about 0.005 micron (50 Angstroms).

“Reverse Osmosis” means a filtration media having pore sizes less than about 0.0005 micron (5 Angstroms).

“Sonochemistry” refers to the chemical applications of ultrasound.

“Ultrafiltration” means a filtration media having a pore sizes from about 0.005 micron to about 0.1 micron.

“Ultrasonic” refers to sound waves that have frequencies above the upper limit of the normal range of human hearing (e.g., above about 20 kilohertz).

“Ultrasonically induced cavitation” refers to cavitation that is directly of indirectly initiated by a source of ultrasonic energy such as ultrasonic transducers.

A consideration of the remainder of the disclosure will facilitate a better understanding of the various embodiments of the invention.

### BRIEF DESCRIPTION OF THE DRAWINGS

In describing the embodiments of the invention herein, reference is made to the various drawings, wherein:

FIGS. 1A-1C are plots showing a mass balance before and after cavitation for fluorine and sulfur for 10 μM aqueous solutions of PFOS (FIGS. 1A, 1B) and PFOA (FIG. 1C), as described in Example 1;

FIG. 2 schematically illustrates a degradation mechanism for PFOS;

FIGS. 3A-3B are plots showing the effect of initial PFOA or PFOS concentration on the rate of fluorochemical degradation, as described in Example 2;

FIG. 4 is a plot showing the effect of ultrasonic power density on the first-order rate constant of PFOA or PFOS degradation in aqueous solutions, as described in Example 3;

FIG. 5 is a plot of the degradation rate as a function of ultrasonic frequency for PFOA and PFOS, as described in Example 4;

FIG. 6 is a plot showing the degradation of PFOS over time for aqueous systems of differing origin, as described in Example 5;

FIG. 7 is a plot showing the degradation of C₄ and C₈ fluorochemicals, as described in Example 6;

FIG. 8 is a schematic representation of a system or apparatus for the treatment of water, according to an embodiment of the invention;

FIG. 9 is a schematic representation of a system or apparatus for the treatment of water, according to another embodiment of the invention;

FIG. 10 is a schematic representation of a system or apparatus for the treatment of water, according to still another embodiment of the invention; and

FIG. 11 is a schematic representation of a system or apparatus for the treatment of water, according to still another embodiment of the invention.

### DETAILED DESCRIPTION

The present invention provides a means for achieving the conversion of fluorochemicals to constituent species such as carbon dioxide, fluoride ion and simple sulfates. In the various described embodiments of the invention, the cavitation of aqueous systems is described in which ultrasonically induced cavitation is used to facilitate the degradation of fluorochemicals in an aqueous environment. In the described embodiments, the treatment of fluorochemicals by cavitation may be accomplished under ambient conditions and without the use of chemical additives. Moreover, the invention provides other water treatment technologies that may be combined with ultrasonically induced cavitation for the treatment of fluorochemicals and other components in aqueous systems.

In the cavitation of aqueous systems in general, bubbles are continuously generated and are continuously collapsing. Not wishing to be bound to any theory, it is believed that, during the process of generation and collapse, a pyrolytic reaction occurs at the surface of collapsing cavitation bubbles to break down the structure of the fluorochemicals in an aqueous environment. Ultrasonically induced cavitation facilitates the formation and quasi-adiabatic collapse of vapor bubbles formed from existing gas nuclei. Subsequent transient cavitation results from the growth of such bubbles and their ultimate collapse. The vapors enclosed within the cavitation bubbles are known to attain temperatures from about 4000 to about 6000° K upon dynamic bubble collapse. Nominal temperatures at the interface between collapsing bubble and the water are known to be in the range from about 500 to about 1000° K. The generation of such high temperatures provides in situ pyrolytic reactions in both the vapor phase and in the interfacial regions. The pyrolytic reactions also result in the breakdown of water into hydroxyl radical, hydroperoxyl radical, and atomic hydrogen. These radicals react readily with the compounds in the gas-phase and with the fluorochemicals adsorbed to the bubble interface.

Ultrasonically induced cavitation is effective for the degradation of the fluorochemical components that partition into the air-water interface, (e.g., compounds such as PFOS and PFOA) as well as compounds having high Henry's Law constants that may tend to partition into the vapor phase of the bubble. Such vapor phase constituents may include volatile fluorochemical fragments and the like.

In embodiments of the present invention, fluorochemicals are treated by using ultrasonically induced cavitation to thereby break down any of a variety of fluorochemicals in aqueous systems. These embodiments are effective for breaking down fluorochemicals having carbon chain lengths from C₁ and higher. In some embodiments, the fluorochemicals for which the invention is useful can include without limitation, C₁ compounds, C₂ compounds, C₄ compounds such as perflurobutane sulfonate and the perfluorobutanoate anion (i.e., the conjugate base of perfluorobutanoic acid), C₆ compounds including the conjugate base of C₆ acids and C₆ sulfonates and C₈ fluorochemicals which include PFOS and PFOA (e.g., the conjugate base thereof), for example. Combinations of two or more of the foregoing are also contemplated within the scope of the invention as well as combinations of fluorochemicals with other organic and/or inorganic species. Moreover, the present invention is not limited in any manner by the source of the fluorochemicals being treated. For example, the fluorochemicals may be treated according to an embodiment of the invention regardless of whether the fluorochemicals materials originate from chemical storage facilities, comprise fire fighting foams (e.g., comprising PFOS and perfluorohexane sulfonate), chemical waste, or the like.

In embodiments of the invention, ultrasonic transducers provide ultrasonically induced cavitation to an aqueous system comprising fluorochemicals. Suitable ultrasonic transducers are available commercially such as those available from L-3 Nautik GMBH in Germany; Ultrasonic Energy Systems in Panama City, Fla.; Branson Ultrasonics Corporation of Danbury, Conn.; and Telsonics Ultrasonics in Bronschhofen, Germany.

In aqueous systems in which the concentrations of fluorochemicals is within the range from about 0.025 ng/mL to about 10⁶ ng/mL (1000 mg/L) ultrasonically induced cavitation may be accomplished using acoustic frequencies within the range from about 15 kHz to about 1100 kHz. In some embodiments, cavitation is accomplished using acoustic frequencies greater than 200 kHz. In some embodiments, cavitation is accomplished using acoustic frequencies ranging from greater than 200 kHz to about 1100 kHz. In other embodiments, cavitation is accomplished using acoustic frequencies within the range from greater than 200 kHz to about 600 kHz.

In an embodiment, cavitation is accomplished using an acoustic frequency of about 20 kHz. In another embodiment, cavitation is accomplished using an acoustic frequency of about 205 kHz. In another embodiment, cavitation is accomplished using an acoustic frequency of about 358 kHz. In another embodiment, cavitation is accomplished using an acoustic frequency of about 500 kHz. In still another embodiment, cavitation is accomplished using an acoustic frequency of about 618 kHz. In still another embodiment, cavitation is accomplished using an acoustic frequency of about 1078 kHz.

In any of the foregoing embodiments, suitable power densities may typically range from about 83 to about 333 W L⁻¹. Variations to the power densities at a given frequency can effect the overall degradation rate of a fluorochemical, and the present invention is not limited in any way by the power density ranges described herein. Power densities may be varied as needed or desired and can be less than about 83 W/L or greater than about 333 W/L. The degradation of the fluorochemicals may be confirmed using one or more suitable analytical techniques known to those skilled in the art for the analysis of the gaseous components and for the detection of compounds in water. Suitable techniques include liquid chromatography, gas chromatography, mass spectroscopy, infrared spectroscopy, and ultraviolet/visible (UV/vis) spectroscopy, for example.

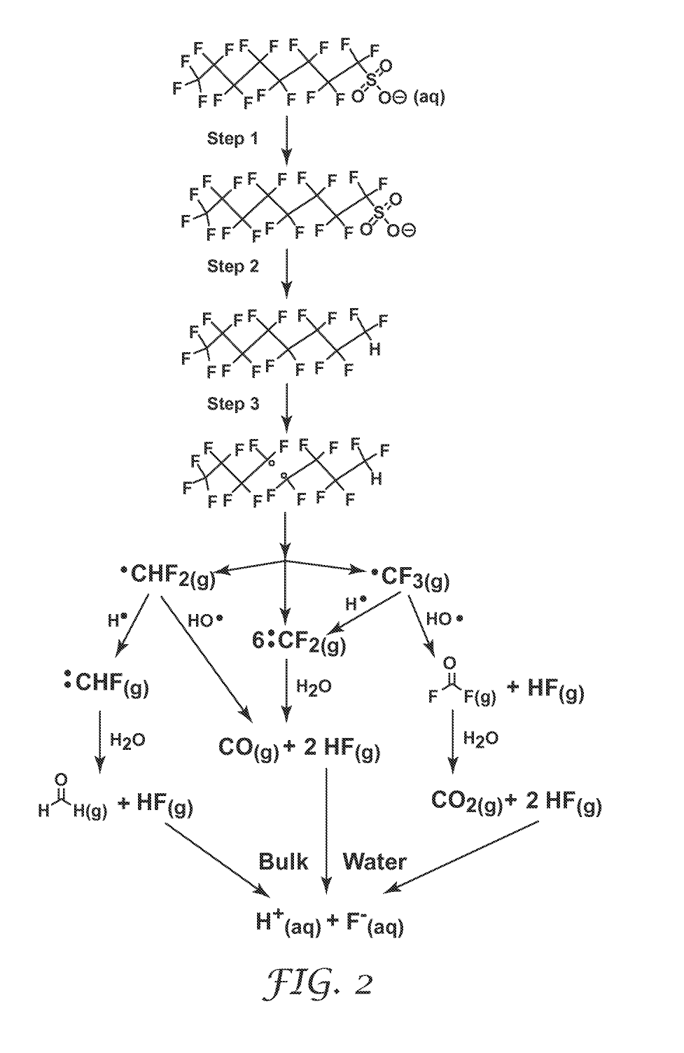

A schematic representation of the general degradation sequence occurring during the ultrasonically induced cavitation of PFOS is illustrated in FIG. 2. A surfactant such as PFOS is typically driven preferentially to the bubble-water interface during ultrasonically induced cavitation where the fluorochemical is adsorbed onto the bubble surface, as indicated in step 1 of FIG. 2. The bubble then collapses (see step 2) creating sufficient heat to initiate pyrolysis of the fluorochemical. The interfacial (e.g., gas/water interface) temperature minimums are estimated to be about 800° K upon bubble collapse.

At 358 kHz and 250 W/L, the measured pseudo first-order degradation rate constant for PFOA is 0.045 min⁻¹. By analysis of the headspace gas generated during the ultrasonic treatment of PFOA or PFOS in water, 20 polyfluorinated alkanes and 52 polyfluorinated alkenes have been noted. The polyflourinated alkanes are predominantly CHF₃, CH₂F₂, CH₃F, C₂F₅H, and C₃F₇H while the polyfluorinated alkenes include species such as CF₂H₂, C₂F₄, C₃F₆ and many C₄-C₈ polyfluorinated alkenes of slightly lower abundance; the total accounting for <1% of the total fluorine at any time. The degradation of intermediate species (e.g. polyfluorinated radicals) (see FIG. 2, step 2) during ultrasonically induced cavitation proceeds faster that the initial decomposition of the PFOS surfactant. The enhanced rates of the non-ionic intermediates compared to their ionic analogs is due to their increased susceptibility toward oxidation, and their larger Henry's Law constants, which favors partitioning of the neutral intermediates into the vapor phase of the bubbles where the maximum temperatures can reach up to 5000° K.

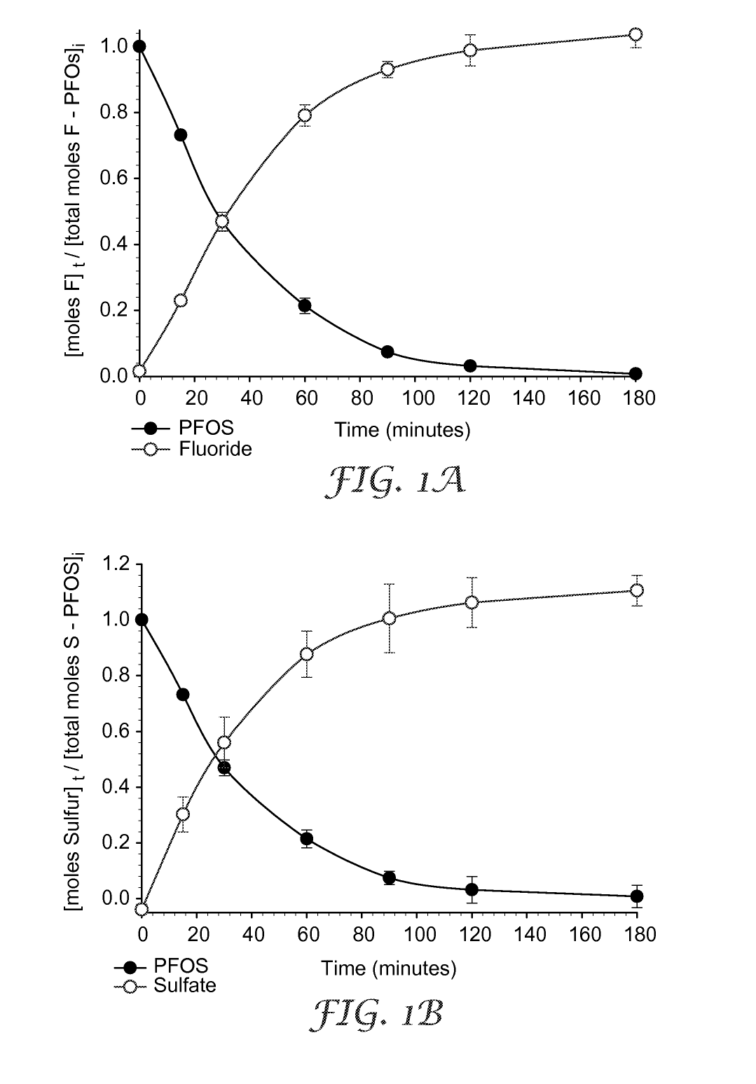

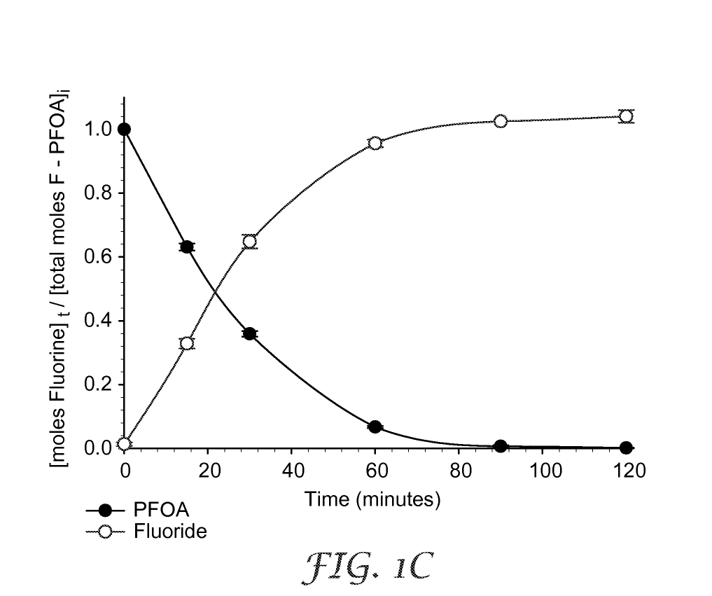

The fluorochemical sulfonate moiety (—CF₂—SO₃⁻) is converted quantitatively to simple sulfate (SO₄²⁻) (e.g., see FIG. 1B) at a rate similar to the loss of PFOS, so that:

−d[PFOS]/dt)≈+d[SO₄²⁻/dt.

While not wishing to be bound to a particular theory, it is believed that PFOS pyrolysis likely proceeds via the formation of sulfur oxyanion and other intermediates such as SO₃, SO₃F, HSO₃⁻, or SO₃²⁻ which are readily hydrolyzed or oxidized to SO₄²⁻.

Step 3, FIG. 2, illustrates that the degradation of the fluorinated intermediates within collapsing bubbles will occur initially through the breaking of covalent —C—C— bonds, thus producing two fluorinated alkyl radicals. At temperatures of about 2000° K, the estimated half life of the carbon to carbon bond is about 22 nanoseconds (ns).

As shown in step 4, FIG. 2, over the same temperature range as in step 3, the resulting fluorinated alkyl radicals have estimated thermal decomposition half-lives of less than one nanosecond with the subsequent production of difluorocarbene or tetrafluoroethylene fragments. These fragments, in turn, thermally decomposes to yield two difluorocarbenes and eventually a trifluoromethyl radical. The trifluoromethyl radical is believed to react with H-atom or hydroxyl radical to yield difluorocarbene or carbonyl fluoride respectively. The difluorocarbene produced will hydrolyze with water vapor to give a carbon monoxide and two hydrofluoric acid molecules. Carbonyl fluoride can also hydrolyze with water vapor to give carbon dioxide and hydrofluoric acid, which, at the appropriate pH (e.g., greater than 3) will dissociate upon solvation to a proton and fluoride. Fluorochemical fluoride is quantitatively converted to free fluoride (see, e.g., FIGS. 1A and 1C).

The carbon backbone of the fluorochemical is converted primarily to formate (HCO₂⁻), carbon monoxide and carbon dioxide. The nearly quantitative carbon mass balance is represented as

((HCO₂⁻+CO+CO₂)/nC_{FC})

Where:
FC means fluorochemical;
n is number of carbons in the original fluorochemical.

The mass balance would provide additional evidence for a mechanism that involves the shattering of the perfluoro-alkene or perfluoro-alkane chains where the fluoride radicals are converted to HCO₂⁻+CO+CO₂ via secondary oxidation, reduction or hydrolysis.

The ultrasonic acoustic cavitation of aqueous solutions comprising fluorochemicals is an effective process for the degradation of these compounds over a wide range in concentrations, under ambient conditions, and without the use of chemical additives. Numerous applications are contemplated for the ultrasonic cavitation of aqueous fluorochemical systems.

In some embodiments, the invention provides systems, apparatuses and related processes in which one or more other water treatment technologies are combined with the ultrasonic technology described herein. In some embodiments, liquid separation technologies are coupled with ultrasonically induced cavitation in a remediation process for liquids such as the degradation of fluorochemicals in water, for example. An aspect of the foregoing embodiments includes the initial treatment of the liquid by one or more separation technologies such as by filtration technologies including ultrafiltration, nanofiltration and reverse osmosis, for example. Thereafter, ultrasonically induced cavitation is employed to the concentrated material blocked by filtration or reverse osmosis. In some aspects, ultrasonically induced cavitation can be applied to treat effluent from the filtration/osmosis step. In other aspects, ultrasonically induced cavitation can be applied to treat both the concentrated material as well as the effluent following a filtration or reverse osmosis step.

In other embodiments, the invention provides systems, apparatuses and related processes in which ion exchange technology is combined with the ultrasonic technology described herein. In some embodiments, ion exchange technology is coupled with ultrasonically induced cavitation in a remediation process for liquids such as the removal of fluorochemicals from water, for example. In an aspect of the foregoing embodiments, ultrasonically induced cavitation is used to degrade fluorochemicals an other substances in a regenerant solution obtained from an ion exchange bed following a regeneration treatment of the bed.

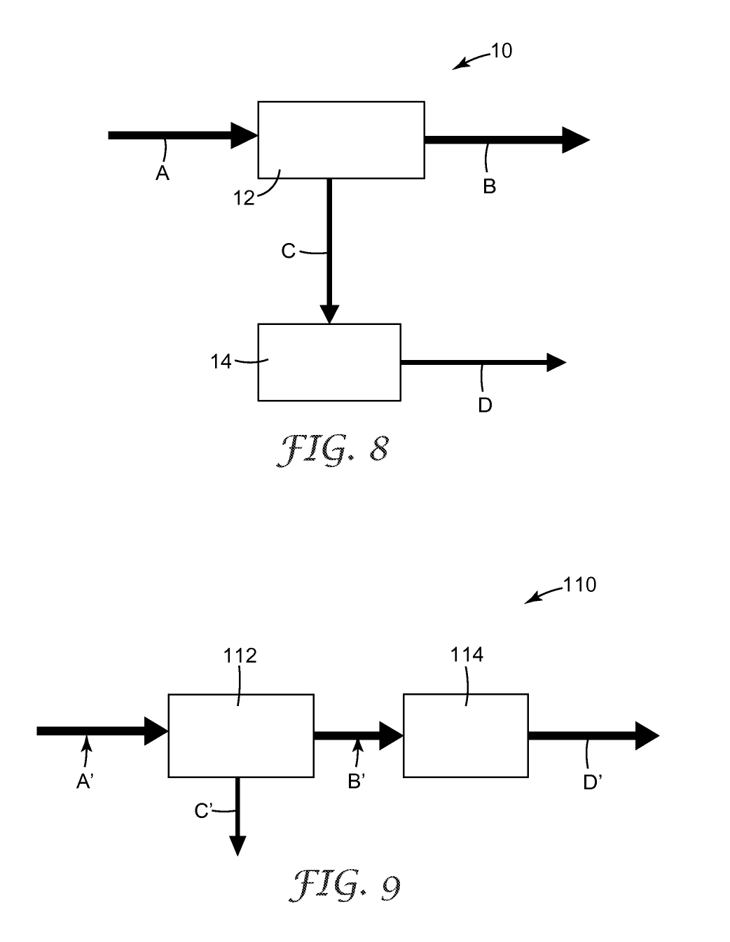

Referring to the Figures, FIG. 8 is a schematic representation of an embodiment of a system and process that employs separation technology in combination with ultrasonically induced cavitation. The system 10 will now be described for the treatment of fluorochemicals in water, but those skilled in the art will appreciate that the configuration of the system is applicable to other aqueous systems. In the system 10, a first stream or volume of water comprising fluorochemicals, in the form of an influent stream, is represented by arrow A and is fed into a first station 12 capable of rendering a first treatment to the water. The influent water may be pre-treated surface water, industrial water, groundwater, leachate or the like and includes fluorochemicals which are to be removed therefrom. The first station 12 is a filtration station that may comprise an apparatus, station or facility to treat the influent by reverse osmosis, nanofiltration, ultrafiltration, microfiltration and/or particle filtration to remove fluorochemicals and other substances. For the removal of fluorochemicals, first station 12 typically comprises a reverse osmosis technology or a nanofiltration technology or an ultrafiltration technology to remove materials varying in size from less than 20 AMU to those up to about 5×10⁶ AMU. Regarding ultrafiltration, systems and apparatuses suitable for use in the present invention include those described in U.S. Patent Appl. Publication No. 2006/0151392-A1, the entire disclosure of which is incorporated herein by reference thereto.

With respect to the system 10, a second stream or volume of water that includes fluorochemicals is represented by the arrow B and flows from the first station 12, and may be released to the environment or otherwise directed to additional treatment facilities such as a conventional waste water treatment plant, for example. A third stream or volume comprising concentrated filtrate material comes from first station 12 and is represented by arrow C. The concentrated material includes all substances that were rejected by the reverse osmosis or filtration process including the fluorochemicals described herein. Concentrate stream or volume C is directed to a second station 14 which is an ultrasonic station where the concentrate is subjected to ultrasonically induced cavitation as has been described. A fourth stream or volume as an effluent stream from the second station 14, represented by the arrow D, may be released to the environment or otherwise directed to additional treatment facilities such as a conventional waste water treatment plant, for example.

Referring to FIG. 9, a schematic representation of another embodiment of a system and process that employs separation technology in combination with ultrasonically induced cavitation is provided. The system 110, is configured to receive a first stream or volume of water comprising fluorochemicals is represented by arrow A′ and is fed into first station 112 which is a filtration station. The influent stream or volume A may be groundwater, leachate or the like and includes fluorochemicals which are to be removed therefrom. First station 112 may comprise an apparatus, station or facility to filter the influent by reverse osmosis, nanofiltration, ultrafiltration, microfiltration and/or even particle filtration to remove fluorochemicals and possible other substances. For the removal of fluorochemicals, first station 112 typically comprises a reverse osmosis technology or a nanofiltration technology or an ultrafiltration technology, as mentioned with respect to the system 10 shown in FIG. 8. The filtration station 112 generates a second stream or volume as an effluent stream represented by the arrow B′ which flows from the first station 112 and into a second station 114. Second station 114 is an ultrasonic station where the second stream or volume is further treated by ultrasonically induced cavitation, as has been described. A third stream or volume results from the ultrasonic treatment and is shown as an effluent stream from the second station 114, represented by the arrow D′. The third stream may be released to the environment or otherwise directed to additional treatment facilities such as a conventional waste water treatment plant, for example. A fourth stream or volume in the form of concentrated filtrate material comes from first station 112 and is represented by arrow C′. The concentrated material includes the substances that were rejected by the reverse osmosis or filtration process including the fluorochemicals described herein. Concentrate stream or volume C′ may be directed to an additional treatment facility or to a disposal facility where it may be disposed of by incineration, for example.

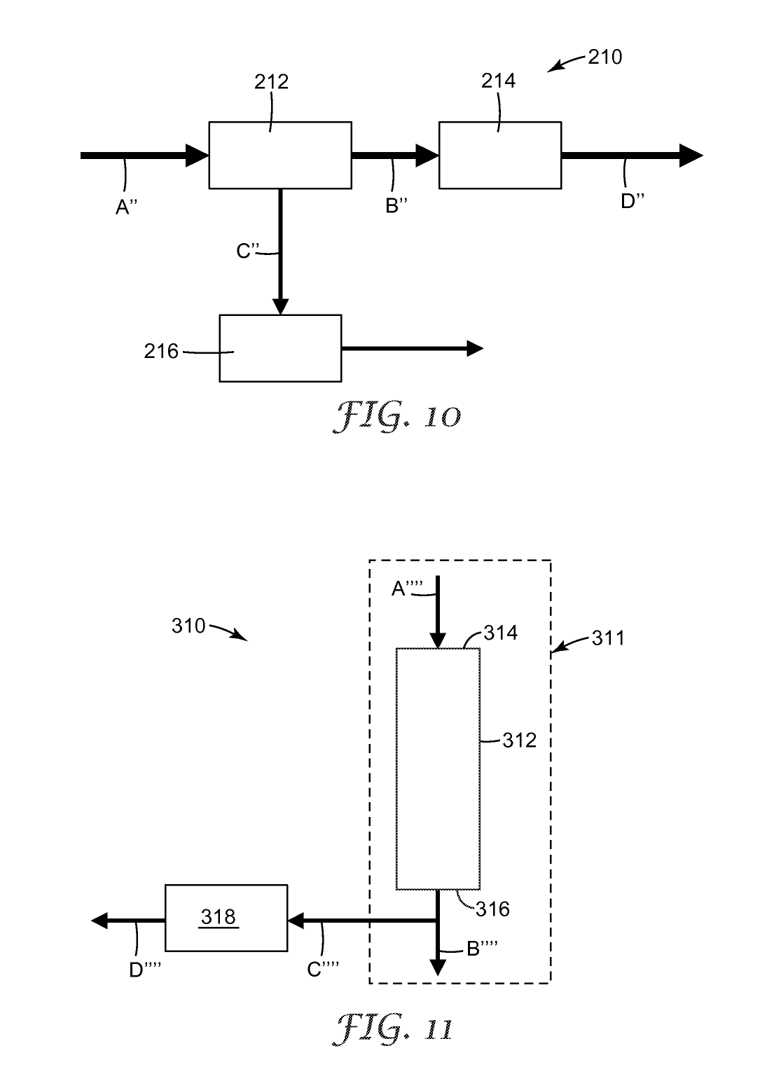

Referring to FIG. 10, is a schematic representation of an embodiment of a system and process that employs separation technology in combination with ultrasonically induced cavitation. The system 210 is configured to receive a first stream or volume of water comprising fluorochemicals as an influent stream represented by arrow A″ is fed into a first station 212 which is a filtration station. The influent water may be groundwater, leachate or the like and includes fluorochemicals which are to be removed therefrom. First station 212 may comprise an apparatus, station or facility to filter the influent by reverse osmosis, nanofiltration, ultrafiltration, microfiltration and/or even particle filtration to remove fluorochemicals and possibly other substances. For the removal of fluorochemicals, first station 212 typically comprises a reverse osmosis technology or a nanofiltration technology or an ultrafiltration technology as described herein. The first station 212 produces a second stream or volume in the form of an effluent stream of water represented by the arrow B″ flowing from the first station 212 and into second station 214 which is an ultrasonic station where the stream is further treated by ultrasonically induced cavitation, as has been described. Following ultrasonically induced cavitation in second station 214, a third stream or volume in the form of an effluent stream, represented by the arrow D″, may be released to the environment or otherwise directed to additional treatment facilities such as a conventional waste water treatment plant, for example. A fourth stream or volume of concentrated filtrate material also results from the filtration step at first station 212 and is represented by arrow C″. The concentrated material includes substances that were rejected by the reverse osmosis or filtration process including the fluorochemicals described herein. The third stream or volume C″ is directed to a third station 216 which is also an ultrasonic station where the concentrate is subjected to ultrasonically induced cavitation as has been described. Following ultrasonically induced cavitation at third station 216, a fourth stream or volume, represented by the arrow E″, is shown as effluent from station 216. The effluent may be released to the environment or otherwise directed to additional treatment facilities such as a conventional waste water treatment plant, for example.

In the foregoing embodiments represented by systems 10, 110 and 210, a filtration station is positioned to receive an initial influent stream prior to subjecting the water to treatment by ultrasonically induced cavitation. Filtration or treatment by reverse osmosis, for example, can be desired, for example, when the influent stream contains substances that may complicate the application of ultrasonic technology for ultrasonically induced cavitation. For example, a filtration step may be needed or desired prior to ultrasonic treatment in order to reduce the levels of unwanted surfactants or emulsions in a liquid stream. The removal of such surfactants may be needed where the presence of a surfactant could otherwise have a negative influence on bubble formation during cavitation and thereby result in a decreased degradation rate of the fluorochemicals. It may also be cost effective to remove the surfactant and incinerate them after filtration when they are in a concentrated form.

In other embodiments of the invention, the use of ultrasonic technology may be combined in a system, apparatus and/or process utilizing ion exchange technology, such as that described in co-pending U.S. Provisional Patent Application entitled “System and Process for the Removal of Fluorochemicals from Water,” Ser. No. 60/890,211 filed on Feb. 16, 2007, the entire disclosure of which is incorporated herein by reference thereto. Referring to FIG. 11, a system 310 is schematically depicted for the removal of fluorochemicals from water. The system 310 includes a first treatment station 311 in the form of an ion exchange flow-through vessel 312 which can be provided in any of a variety of configurations. The vessel 312 may, for example, include a cylindrical column having an ion exchange bed comprised of ion exchange resin contained within the vessel 312. A first stream or volume of water comprising fluorochemicals enters the vessel at a first end 314 as an influent stream of untreated water, represented by the arrow A″″. The first stream or volume is pumped into the vessel 312 through the first end 314 and through the ion exchange bed. Fluorochemicals and other contaminants in the water stream are removed from the water by the ion exchange mechanism provided by the resins in the ion exchange bed. A second stream or volume of treated water is directed out of the vessel 312 through second end 316 at the opposite end of the vessel 312 from the first end 314 as an effluent stream represented by the arrow B″″. Second stream or volume B″″ may be released to the environment or otherwise directed to additional treatment facilities such as a conventional waste water treatment plant, for example.

Over time, the ion exchange bed in the first station 311 can become saturated with fluorochemicals and other materials and will require regeneration to restore the ion exchange resin to pick up fluorochemicals from an influent stream of water. In the regeneration process, the fluorochemicals in the ion exchange bed 314 are replaced with a cation such as calcium, sodium or the like. Fluorochemical material released from the bed 314 is typically in the form of a concentrated regenerant liquid. In the system 310, the regenerant is represented as a third stream or volume flowing from the second end 316 of the vessel 312, represented by the broken arrow C″″. The third stream is diverted to flow into a second station 318 which is an ultrasonic station where the concentrated regenerant is subjected to ultrasonically induced cavitation as has been described. A fourth stream or volume in the form of an effluent stream from the second station 318, represented by the arrow D″″, is produced by the ultrasonically induces cavitation and may be suitable for release to the environment or otherwise directed to additional treatment facilities such as a conventional waste water treatment plant, an incinerator facility, or the like.

### Examples

Additional embodiments of the invention are further described in the following non-limiting Examples.

Procedure A: Standards and Reagents

Ammonium perfluorooctanoate (APFO) and sodium perfluorooctane sulfonate (NaPFOS) standards were obtained from 3M Company of St. Paul, Minn. The standards from 3M Company included both linear and branched isomers of APFO and PFOS in methanol and were diluted to obtain a desired concentration for PFOS and/or PFOA.

Perfluorobutanoic acid (PFBA) was obtained from Sigma-Aldrich. Sodium perfluorobutane sulfonate (NaPFBS) was obtained from 3M Company of St. Paul, Minn. The samples were diluted to obtain a desired concentration for PFBA and/or PFBS.

Procedure B: Ultrasonic Acoustic Cavitation Experiments

Ultrasonic Acoustic Cavitation experiments were conducted at frequencies of 205, 358, 618 and 1078 kHz were performed using an ultrasonic generator (from L-3 Nautik GMBH in Germany) in a 600 mL glass reactor. The temperature was controlled with a refrigerated bath (either a Haake A80 or Neslab RTE-111) maintained at 10° C.

For mass balance experiments, the L-3 Nautik reactor was sealed to atmosphere for trace gas analysis.

Ultrasonic acoustic cavitation experiments at 20 kHz were performed with an ultrasonic probe (Branson Cell Disruptor from Branson Ultrasonics Corporation of Danbury, Conn.) in a 300 mL glass reactor. The titanium probe tip was polished prior to use for all experiments and on every hour for some. The temperature was controlled with a refrigerated bath (Haake FK2) at 10° C.

Procedure C: Water Analyses

Ammonium Acetate (>99%) and Methanol (HR-GC>99.99%) were obtained from EMD Chemicals Inc. Aqueous solutions were used in liquid chromatography/mass spectroscopy (LC/MS) and were prepared with purified water prepared using a Milli-Q water purification system (18.2 mΩcm resistivity) obtained from Millipore Corporation of Billerica, Mass.

Analysis for initial fluorochemicals and possible shorter-chain degradation products was completed by high performance liquid chromatography-mass spectroscopy (HPLC-MS). Sample aliquots (700 μL) were withdrawn from the reactor using disposable plastic syringes. The samples were placed into 750 μL polypropylene autosampler vials and sealed with a polytetrafluoroethylene (PTFE) septum crimp cap. For reactions with initial fluorochemical concentrations greater than 250 ppb, serial dilutions to achieve a concentration around 500 ppb were completed prior to analysis. 20 μL of collected or diluted sample was injected onto an Agilent 1100 LC for separation on a Betasil C18 column (Thermo-Electron) of dimensions 2.1 mm ID, 100 mm length and 5 μm particle size. A 0.01 M aqueous ammonium acetate-methanol mobile phase at a flow rate of 0.3 mL/min was used with an initial composition of 70:30 aqueous: methanol holding for two minutes followed by a six minute ramp to 25:75 holding for six minutes, then a minute ramp to 0:100 and a 1 minute hold to wash the column and finally a minute ramp back to initial conditions. Separated samples were analyzed by an Agilent Ion Trap in negative mode monitoring for the perfluoro-sulfonate molecular ion and the decarboxylated perfluorocinated-acid. The nebulizer gas pressure was 40 PSI, drying gas flow rate and temperature were 9 L/min and 325° C., the capillary voltage was set at +3500 V and the skimmer voltage was −15 V. Quantification was completed by first producing a calibration curve using 8 concentrations between 1 ppb and 200 ppb fitted to a quadratic with 1/× weighting.

Procedure D: Ion Chromatography

Ion chromotagraphy was used to determine the concentration of fluoride and sulfate. Sample preparation included dilution of the samples by a factor 1:100 to get the samples within the operating range of the ion chromatography equipment. The following equipment and operating parameters were employed in the analysis of the sample replicates.

Dionex DX500 Chromatography System

Dionex GP50 Standard bore Gradient Pump

Dionex ASRS Ultra II 4 mm Suppressor

Dionex CD20 Conductivity Detector

Dionex AS11A Column, 4 mm

Dionex AG11A Guard Column, 4 mm

Dionex AS40 Autosampler, Inert Peek Flow Path

Eluent: 18-MΩ·cm water, 0.2-35 mM KOH by EG40 Eluent Generator

Injection: 250 μL

Flow Rate: 1.0 mL/min.

A calibration curve was obtained and the data was quantified using at least a 5-point point linear calibration curve. The correlation coefficient was at least 0.998 for each analyte and the curve was not forced through zero. The lower limit for quantification was the lowest standard concentration employed. The calibration standards were prepared from a mixed anion stock (Mix 5) purchased from Alltech Associates, Inc., Lot #ALLT170051 and a 99% trifluoroactic acid standard from ACROS Lot #B0510876. Standards were diluted with Milli-Q (18 MΩ·cm) water.

Continuing Calibration Verifications (CCVs) were run at least every 10 sample injections and at the end of each analytical sequence to verify consistent system operation. The CCV recoveries ranged from 97-102%. Continuing Calibration Blanks (CCBs) containing 18-MΩ·cm water (extraction solution) were analyzed after every 10 injections and at the end of each analytical sequence to verify that the system operation was consistent.

Method blanks containing 18-MΩ·cm water (extraction solution) were prepared and analyzed. The target analytes were not detected above the method reporting limit. Method spikes were prepared and analyzed. A vial containing extraction water was spiked with a mid-level certified standard containing all three analytes. The average method spike recoveries ranged from 98-111%. Matrix spikes were prepared and analyzed in duplicate. Three individual vials containing 1:100 diluted sample were spiked with a certified standard containing all three analytes. The average matrix spike recoveries ranged from 95-102%, 95-107%, and 103-115%.

Procedure E: Trace Gas Analysis

The gaseous headspace was analyzed for trace gases. A reactor sealed from the outside atmosphere was used for these measurements and any gases formed were not circulated back into solution. For headspace gas analysis, a 300 mL gas reservoir was added to the recirculation line. A similar sized evacuated can was used to collect the gas content of the headspace. The can was sent for analysis using gas chromatography/mass spectroscopy (GC-MS) as well as by real-time FTIR (Model-I2001, 4 meter white cell, available from Midac Corporation of Costa Mesa).

### Example 1

Multiple PFOS and PFOA solutions were prepared as in Procedure A at initial concentrations of about 10 μM for each of the two fluorochemicals (note: 1 ppm=2.0 μM PFOS and 2.4 μM PFOA). The initial solution pH was ˜6.5 for PFOA⁻NH₄⁺ and ˜8.0 for PFOS⁻K⁺, and the pH was maintained above 4.5 to prevent formation of hydrofluoric acid (pKa=3.14). Ultrasonic Acoustic Cavitation was applied to the PFOS and PFOA solutions according to Procedure B at an acoustic frequency of 358 kHz and a power density of 250 W/L.

Degradation of the fluorochemicals was monitored. The initial fluorochemicals PFOS and PFOA were monitored by analysis of water samples using LC/MS according to Procedure C above. Aqueous fluoride ion, formate ion, and sulfate were monitored by ion chromatography according to Procedure D above. Carbon monoxide (CO) and carbon dioxide (CO₂) were monitored using FTIR as in Procedure E. Additionally, analysis of the gaseous headspace in the reactor by FTIR and GC-MS according to Procedure E showed trace levels of a number of polyfluorinated alkanes and olefins. Release of CO and CO₂ to the overlying headspace occurred immediately after the initial pyrolytic decomposition of the parent compounds.

Referring to FIGS. 1A-1C, mass balance determinations of total fluorine and sulfur as functions of time are shown. These plots show the degradation of the initial fluorochemicals and the concomitant increase in fluoride ion and sulfate concentrations.

### Example 2

Multiple solutions of PFOA and PFOS were prepared according to Procedure A. Samples of PFOA were made to cover the concentration range from 0.01 mg/L to 990 mg/L, and samples of PFOS were made to cover the concentration range from 0.01 mg/L to 820 mg/L. The samples were subjected to ultrasonically induced cavitation at a frequency of 358 kHz and a power density of 250 W/L using an ultrasonic generator from L-3 Nautik GMBH in Germany and a 600 mL glass reactor as in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants.

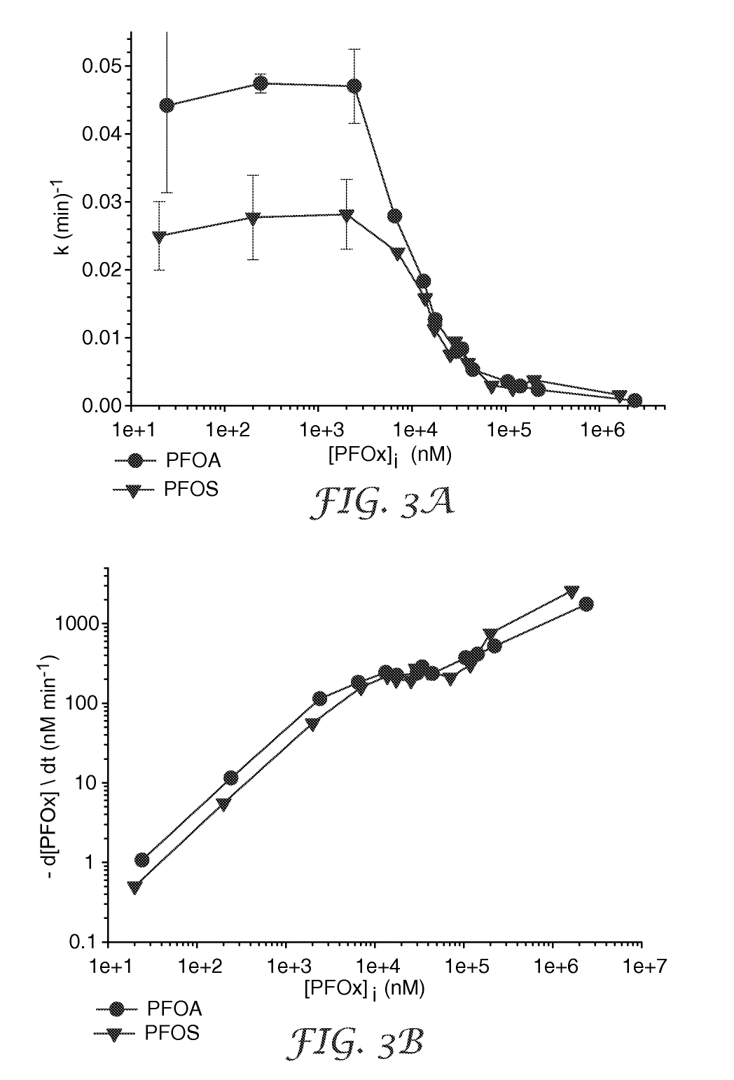

Referring to FIG. 3A, the pseudo first-order rate constants have been plotted against initial concentrations of PFOA and PFOS. In the concentration range of 20 nM to 2000 nM, the rate constants are 0.047 min⁻¹ and 0.028 min⁻¹ for PFOA and PFOS, respectively. Over the concentration range of 2000 nM and 40,000 nM, the pseudo first-order rate constant decreases linearly with a slope of −10⁻³ min⁻¹ μM⁻¹ In FIG. 3B absolute degradation rates of PFOS and PFOA are plotted against the initial concentrations of the fluorochemicals. Between 20 nM and 2000 nM, the absolute degradation rates increase by two orders of magnitude from 1.1 to 113 nM min⁻¹ for PFOA and from 0.5 to 56 nM min⁻¹. Between 6000 nM and 140,000 nM, the absolute rate of degradation levels off at around 200 nM min⁻¹.

The decrease in the apparent rate constant and leveling off of the absolute rate over the depicted concentration range suggests a change in sorption regimes from a linear sorption isotherm to a non-linear sorption isotherm which can be described by a Langmuir isotherm

Γ_{FC}=Γ_{FC,max}[K_{L}[FC]/1+K_{L}[FC]].
where
   FC means fluorochemical;
   Γ_{FC} is the surface concentration of a fluorochemical;
   Γ_{FC,max} is the maximum surface concentration of a fluorochemical; and
   K_{L} is the equilibrium adsorption coefficient.

Thus, the absolute rates of degradation reach a saturation level as the available surface sites on the bubble are fully occupied. In addition, convergence of the rate constants for PFOA and PFOS degradation is

−(d[PFOA]/dt)≈−(d[PFOS]/dt),

suggesting the overall rates are sorption controlled rather than thermally controlled. In this concentration regime, the apparent first-order rate constant actually increases with time because as the concentration of PFOx is decreased. The fraction of PFOx adsorbed to the surface of an ultrasonically induced cavitation bubble is [PFOx]_{surface}. The total amount of PFOx is [PFOx]ₜₒₜₐₗ. The ratio [PFOx]_{surface}/[PFOx]ₜₒₜₐₗ increases with time and shifts towards a steeper region of the sorption isotherm.

Above 40,000 nM, the observed pseudo first-order rate constants reach an apparent constant value of 0.0025 min⁻¹ at a PFOS (or PFOA) concentration of 40,000 nM and the apparent pseudo order of the reaction shifts from first order to zero order as the bubble surface nears saturation. However, above 40,000 nM, the absolute rate of PFOS (or PFOA) degradation appears to increase. Surfactant accumulation will result in a decrease in surface tension. The formation of ultrasonically driven bubbles requires that the applied acoustic power must be greater than the total bubble surface energy,

Π≧N_{b}σ<S>
Where
   Π is the applied power in Watts;
   N_{b} is the total number of bubbles;
   σ is the surface tension in N/m; and
   <S> is the average bubble surface area in cm².

Therefore, as surface tension is decreased, the total number of bubbles, and the number of available surface sites increases allowing for greater degradation rates. As a consequence, the observed saturation effect is the product of offsetting effects of surface sites limitation and surface tension reduction.

### Example 3

Multiple solutions of PFOA and PFOS were prepared according to Procedure A to a concentration of 100 ng/ml per fluorochemical. The samples were subjected to ultrasonically induced cavitation at a frequency of 618 kHz at different power densities using an ultrasonic generator from L-3 Nautik GMBH in Germany and a 600 mL glass reactor as in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants. Operating parameters and rate constants are set forth in Table 1.

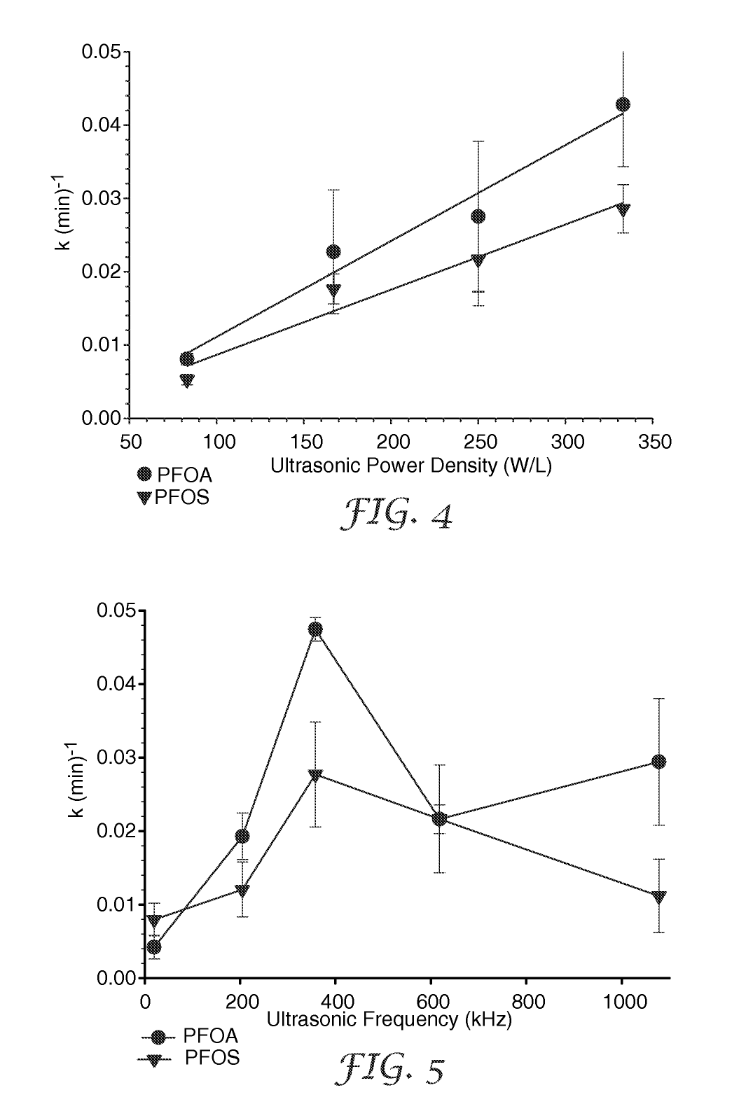

The observed dependence of the pseudo first-order rate constants on the ultrasonic power density at 618 kHz is set forth in the plot of FIG. 4. The measured rate constants increase with increasing power density for both fluorochemicals, as shown in FIG. 4. An increase in power density increases the number of cavitation bubbles (N_{b}), and in turn the total number of surface catalytic sites.

TABLE 1

| | | | | |
|---|---|---|---|---|
| Frequency (kHz) | 618 | 618 | 618 | 618 |
| Applied Power (W) | 50 | 100 | 150 | 200 |
| Calorimetric Power (W) | 33 | 78 | 125 | 188 |
| Acoustic Pressure (bar) | 2.05 | 3.15 | 3.99 | 4.89 |
| Acoustic Half-Period (us) | 0.8 | 0.8 | 0.8 | 0.8 |
| Collapse Time (us) | 0.25 | 0.3 | 0.35 | 0.4 |
| Rmax (micron) | 4.25 | 7.91 | 10.4 | 13.1 |
| Tmax(K, gas) | | | | |
| k[PFOA] expt min − 1 | 0.0081 | 0.0227 | 0.0275 | 0.0428 |
| k[PFOS] expt min − 1 | 0.00525 | 0.0176 | 0.0217 | 0.0286 |

### Example 4

Multiple solutions of PFOA and PFOS were prepared according to Procedure A so that each fluorochemical was present in solution at a concentration of 100 ng/mL. The solutions were subjected to ultrasonic acoustic cavitation experiments at frequencies of 20, 205, 358, 618 and 1078 kHz as described in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants.

Referring to FIG. 5, the degradation rate as a function of ultrasonic frequency is shown for PFOA and PFOS. Over the frequency range from 20 to 1078 kHz, the degradation rates for both PFOS and PFOA have maximums at 358 kHz.

### Example 5

Samples of groundwater and landfill leachate (or porewater) were obtained. Additionally, solutions of 100 ng/ml of PFOS were prepared as in Procedure A. All of the solutions were subjected to ultrasonic acoustic cavitation experiments at a frequency of 358 kHz and a power density of 250 W/L as described in Procedure B. The degradation of PFOS was monitored by analysis of water samples using LC/MS according to Procedure C.

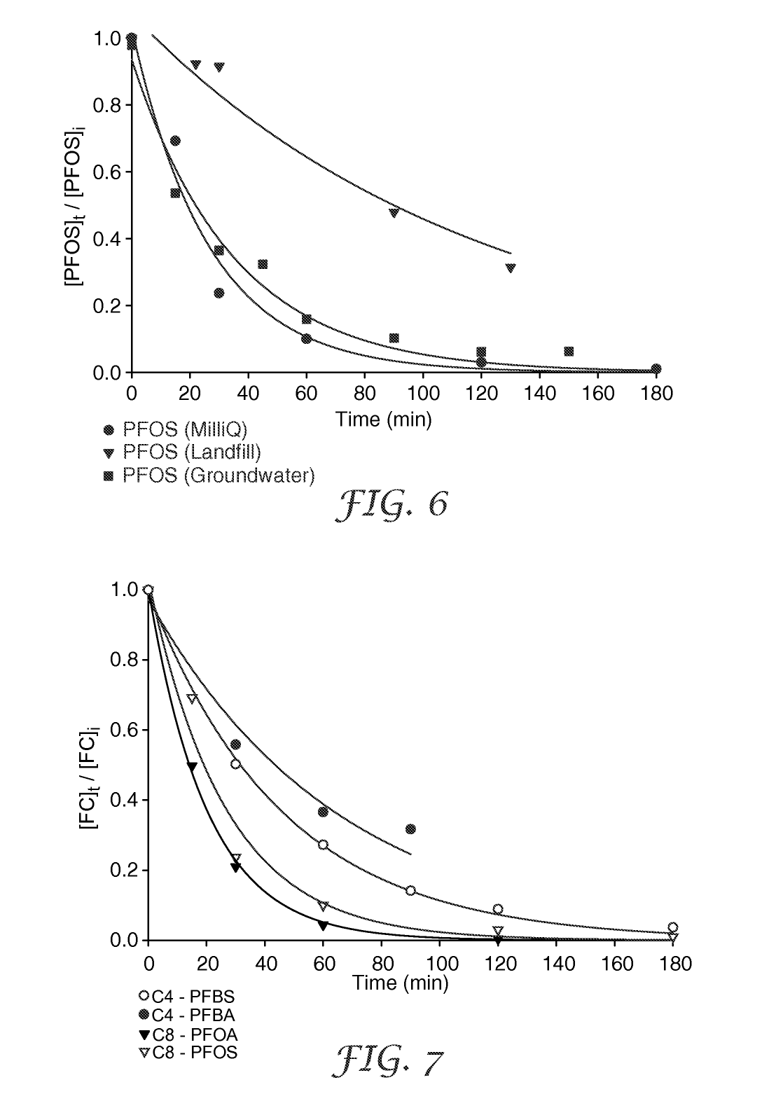

The pseudo first order rate constants were 0.03 min⁻¹, 0.03 min⁻¹ and 0.008 min⁻¹ for PFOS present in purified water, groundwater and landfill leachate, respectively. Referring to FIG. 6, the concentration of PFOS at a given time divided by its initial concentration is plotted as a function of time for each of the samples tested.

### Example 6

Multiple solutions of PFOA, PFOS and smaller C₄ fluorochemicals (perflurobutane sulfonate and perfluorobutanoic acid) were prepared to have a concentration for each fluorochemical of 100 ng/ml. Solutions of PFOA and PFOS were prepared according to Procedure A. The samples were subjected to ultrasonically induced cavitation at a frequency of 358 kHz at a power density of 250 W/L using an ultrasonic generator from L-3 Nautik GMBH in Germany and a 600 mL glass reactor as in Procedure B. Degradation of the fluorochemicals was monitored by analysis of water samples using LC/MS according to Procedure C above. The degradation data was used to prepare plots of the concentration of fluorochemical at a given time divided by its initial concentration as a function of time. The pseudo first order rate constants were 0.021 min⁻¹ for PFBS, 0.015 min⁻¹ for PFBA, 0.04 min⁻¹ for PFOA and 0.03 min⁻¹ for PFOS. The resulting degradation curves are set forth in FIG. 7.

Various embodiments of the invention have been described in detail. Those skilled in the art will appreciate that changes and modifications to the described embodiments may be made without departing from the spirit and scope of the invention.

What is claimed is:

1. A system for the treatment of fluorochemicals in an aqueous environment, comprising:
A first treatment station configured to receive a first stream or volume of water comprising fluorochemicals, the first treatment station configured to provide a first treatment to the first stream or volume of water to thereby provide a second stream or volume of water comprising fluorochemicals;
A second treatment station configured to receive the second stream or volume of water from the first treatment station, the second treatment station configured to treat the second stream or volume of water by ultrasonically induced cavitation at a frequency within the range from about 15 kHz to about 1100 kHz.

2. The system of claim 1 wherein the first treatment station is a filtration station.

3. The system of claim 2 wherein the filtration station comprises a reverse osmosis station, an ultrafiltration station or nanofiltration station.

4. The system of claim 1 wherein the first treatment station is an ion exchange bed and the second treatment station is configured to receive the second stream or volume of water in the form of regenerant liquid from the first treatment station.

5. The system of claim 1 wherein the second station is configured to treat the second stream or volume of water with ultrasonically induced cavitation at a frequency greater than 200 kHz.

6. The system of claim 1 wherein the second station is configured to treat the second stream or volume of water with ultrasonically induced cavitation at a frequency within the range from greater than about 200 kHz to about 600 kHz.

7. The system of claim 1 wherein the second station is configured to treat the second stream or volume of water with ultrasonically induced cavitation at a frequency selected from the group consisting of about 20 kHz, about 205 kHz, about 358 kHz, about 500 kHz, about 618 kHz, about 1078 kHz.

8. The system of claim 1 wherein the second station is configured to treat the second stream or volume of water with ultrasonically induced cavitation at a power density within the range from about 83 W L⁻¹ to about 333 W L⁻¹.

9. The system of claim 1 wherein the second station is configured to treat the second stream or volume of water with ultrasonically induced cavitation at a power density less than about 83 W/L.

10. The system of claim 1 wherein the second station is configured to treat the second stream or volume of water with ultrasonically induced cavitation at a power density greater than about 333 W/L.

11. The system of claim 1 further comprising a third treatment station configured to receive the second stream or volume of water from the first treatment station, the third treatment station configured to treat the second stream or volume of water by ultrasonically induced cavitation at a frequency within the range from about 15 kHz to about 1100 kHz.

12. The system of claim 11 wherein the third station is configured to treat the second stream or volume of water with ultrasonically induced cavitation at a frequency greater than 200 kHz.

13. The system of claim 11 wherein the third station is configured to treat the second stream or volume of water with ultrasonically induced cavitation at a frequency within the range from greater than about 200 kHz to about 600 kHz.

14. The system of claim 11 wherein the third station is configured to treat the second stream or volume of water with ultrasonically induced cavitation at a frequency selected from the group consisting of about 20 kHz, about 205 kHz, about 358 kHz, about 500 kHz, about 618 kHz, about 1078 kHz.

15. The system of claim 11 wherein the third station is configured to treat the second stream or volume of water with ultrasonically induced cavitation at a power density within the range from about 83 W L⁻¹ to about 333 W L⁻¹.

16. The system of claim 11 wherein the third station is configured to treat the second stream or volume of water with ultrasonically induced cavitation at a power density less than about 83 W/L.

17. The system of claim 11 wherein the third station is configured to treat the second stream or volume of water with ultrasonically induced cavitation at a power density greater than about 333 W/L.

18. A process for the treatment of fluorochemicals in water, comprising:
Applying a first treatment to a first stream or volume of water comprising fluorochemicals, the first treatment producing a second stream or volume of water comprising fluorochemicals; and
Applying a second treatment to the second stream or volume of water, the second treatment comprising ultrasonically induced cavitation at a frequency within the range from about 15 kHz to about 1100 kHz to thereby breaking down the fluorochemicals into constituent components.

19. The process of claim 18 wherein the first treatment further produces a third stream or volume of water comprising fluorochemicals, the process further comprising: applying a third treatment to the third stream or volume of water, the third treatment comprising ultrasonically induced cavitation at a frequency within the range from about 15 kHz to about 1100 kHz to thereby breaking down the fluorochemicals into constituent components.

20. The process of claim 18 wherein applying a first treatment is accomplished at a first treatment station

21. The process of claim 20 wherein the first treatment station is a filtration station and the first treatment is filtration of the stream or volume of water.

22. The process of claim 20 wherein the filtration station comprises a reverse osmosis station, an ultrafiltration station, or a nanofiltration station.

23. The process of claim 18 wherein the first treatment station comprises an ion exchange bed.

24. The process of claim 18 wherein the ultrasonically induced cavitation is performed at a frequency greater than 200 kHz.

25. The process of claim 18 wherein the ultrasonically induced cavitation is performed at a frequency within the range from greater than 200 kHz to about 1100 kHz.

26. The process of claim 18 wherein the ultrasonically induced cavitation is performed at a frequency within the range from greater than 200 kHz to about 600 kHz.

27. The process of claim 18 wherein the ultrasonically induced cavitation is performed at the frequency of about 20 kHz, about 205 kHz, about 358 kHz, about 500 kHz, about 618 kHz, about 1078 kHz.

28. The process of claim 18 wherein the ultrasonically induced cavitation is at a power density within the range from about 83 W L⁻¹ to about 333 W L⁻¹.

29. The process of claim 18 wherein the ultrasonically induced cavitation is at a power density less than about 83 W/L.

30. The process of claim 18 wherein the ultrasonically induced cavitation is at a power density greater than about 333 W/L.

31. The process of claim 18 wherein the fluorochemicals comprise compounds having a carbon chain length of C₁ and higher.

32. The process of claim 18 wherein the fluorochemicals comprise compounds having a carbon chain length of C₂ and higher.

33. The process of claim 18 wherein the fluorochemicals comprise compounds having a carbon chain length selected from the group consisting of C₄, C₆, C₈ and combinations of two or more of the foregoing.

34. The process of claim 18 wherein the fluorochemicals comprise perfluorooctane sulfonate and perfluorooctanoic acid.
